(19) United States
(12) Patent Application Publication
(10) Pub. No.: US 2010/0254868 A1
(43) Pub. Date: Oct. 7, 2010

(54) PURIFICATION OF A FLUID USING OZONE WITH AN ADSORBENT AND/OR A PARTICLE FILTER

(75) Inventors: Timothy N. Obee, South Windsor, CT (US); Stephen O. Hay, Tolland, CT (US); Susan D. Brandes, South Windsor, CT (US); Leland G. Brandes, South Windsor, CT (US); Thomas Henry Vanderspurt, Glastonbury, CT (US); Wayde R. Schmidt, Promfret Center, CT (US); Norberto O. Lemcoff, Simsbury, CT (US)

Correspondence Address: KINNEY & LANGE, P.A., THE KINNEY & LANGE BUILDING, 312 SOUTH THIRD STREET, MINNEAPOLIS, MN, 55415-1002, US

(73) Assignee: CARRIER CORPORATION, Farmington, CT (US)

(21) Appl. No.: 12/663,954

(22) PCT Filed: Jun. 22, 2007
(86) PCT No.: PCT/US07/14587

§ 371 Date: Dec. 10, 2009

(51) Int. Cl. B01D 53/38; C02F 1/78; C02F 1/42; C02F 1/32; C02F 1/30; A62B 7/08

(52) U.S. Cl. 423/210; 210/760; 210/668; 210/748.15; 210/748.09; 210/748.07; 210/744; 210/192; 422/120

(57) ABSTRACT

A system and method (60) for a purifying a fluid (such as air or water) containing contaminants includes removing the contaminants from the fluid (70) using a capturing device, such as an adsorbent and/or a particle filter. The contaminants may include volatile organic compounds (VOCs) and microorganisms. The method (60) further includes generating ozone molecules using an ozone generating device (62). An ozone decomposition device is used to decompose at least a portion of the ozone molecules into oxygen and oxygen radicals (68). The captured contaminants (VOCs and microorganisms) react with the oxygen radicals and the ozone molecules to denature the contaminants (72), rendering them less harmful than the original contaminants in the fluid. In some cases, the contaminants may be reduced to carbon dioxide and water.

### BACKGROUND

The present invention relates to a purification method and system for a fluid. More particularly, the present invention relates to a purification method and system that uses ozone in combination with an adsorbent and/or a particle filter to remove contaminants from air or water.

Air purification systems that generate ozone have been used to clean contaminated air within a closed space. Because high levels of ozone are dangerous, these air purification systems may require an ozone mitigating component, such as an adsorbent, to capture the ozone downstream and prevent the ozone from traveling to occupied spaces. However, over time, the adsorbent may become saturated and no longer be effective at removing ozone from the air stream. In that case, the adsorbent may need to be replaced.

Adsorbents also may be used within purification systems for capturing contaminants, such as volatile organic compounds (VOCs), and thereby removing the contaminants from a fluid stream. Particle filters may similarly be used for capturing larger-sized contaminants, such as microorganisms. As stated above, the functional life of an adsorbent, as well as a particle filter, may be limited and the purification system may require frequent replacement of the adsorbent or particle filter.

There is a need for an air purification system and method with improved capabilities for removing contaminants from an air stream.

### SUMMARY

The present disclosure relates to a system and method for purifying a fluid stream containing contaminants, such as volatile organic compounds (VOCs) and microorganisms. The contaminants are removed from the fluid stream using a capturing device, such as an adsorbent and/or a particle filter, both of which localize the contaminants. Ozone molecules are introduced into the fluid stream, and an ozone decomposition device is used to decompose at least a portion of the ozone molecules into oxygen and oxygen radicals. The captured contaminants are reacted with the oxygen radicals and the ozone molecules to denature the contaminants. The contaminants are denatured to a less harmful molecule, and in some embodiments, the contaminants are reduced to carbon dioxide and water. The purification method may be completed in a continuous process in which the contaminants are being captured and removed from the fluid stream, while ozone molecules are simultaneously being introduced into the fluid stream. In alternative embodiments, the purification method may be completed as a two phase process, which includes an adsorption phase to remove the contaminants from the fluid, and a regeneration phase to repeatedly attack the contaminants in an adsorbed state using ozone and oxygen radicals.

### BRIEF DESCRIPTION OF THE DRAWINGS

FIG. 1 is a schematic of an air handling system that includes a purification system inside a duct of the air handling system.

FIG. 2 is a schematic of the air handling system of FIG. 1, which includes alternative or additional locations for the purification system of FIG. 1.

FIG. 3 is a schematic of an alternative design of the purification system in which the system is located in a duct by-pass.

FIG. 4 is a block diagram illustrating a purification method for a fluid stream.

FIG. 5 is a schematic of a purification system, including an ozone generating device, an ozone decomposition device and an adsorbent.

FIGS. 6-9 are schematics of alternative embodiments of the purification system of FIG. 5.

FIGS. 10 and 11 are schematics of an additional embodiment of a purification system which operates in two phases and includes a regeneration chamber.

### DETAILED DESCRIPTION

A system and method is described herein for using ozone in combination with an adsorbent and/or a particle filter for purification of a fluid stream containing contaminants. The fluid may be air or water. The contaminants may include volatile organic compounds (VOCs) and microorganisms. Ozone molecules are introduced into the fluid stream to attack the contaminants. A portion of the ozone molecules are decomposed to form oxygen radicals, which are particularly effective at attacking contaminants. The oxygen radicals, however, have a shorter life than the ozone molecules. An adsorbent is used to remove the VOCs from the fluid and localize the VOCs so that the oxygen radicals, as well as the ozone molecules, have an increased probability of coming into contact with and attacking the VOCs. In addition to or as an alternative to the adsorbent, a particle filter may be used to remove and localize the microorganisms, such that the microorganisms may react with the ozone molecules and oxygen radicals. In some embodiments, a single device may be used for capturing both the VOCs and the microorganisms from the fluid.

This purification system and method may be incorporated into an air handling system for a building. FIG. 1 is a schematic of heating, ventilation and air conditioning (HVAC) system 10 for space 12. Space 12 may be an inside of any type of building (for example, a hospital) or an enclosed part of a building. In other embodiments, space 12 may be an enclosed space within a vehicle or another type of transportation device, such as, for example, a ground-based vehicle, an aircraft, spacecraft, or a boat. System 10 includes air purification system 50, and ducts 18 and 20. Air purification system 50 includes ozone generating device 14, air handling unit (AHU) 16, power supply 22, sensors 24, and flow rate control 26. Air handling unit 16 may be used for heating and/or cooling space 12. It is recognized that air handling unit 16 is not required in air purification system 50. In some embodiments, air handling unit 16 may be omitted from system 50; and in other embodiments, air handling unit 16 may be located downstream or upstream of air purification system 50. In the embodiment shown in FIG. 1, ozone generating device 14 is a non-thermal plasma (NTP) device. It is recognized that other devices designed to produce ozone may be substituted for the non-thermal plasma device. NTP device 14 is connected to power supply 22, which delivers electrical power to NTP device 14.

As shown in FIG. 1, outside air 27 enters duct 18 and passes through air purification system 50, which includes passing through NTP device 14 and then passing through AHU 16. Conditioned air 28 then travels through supply duct 18 to space 12. Return duct 20 removes air 29 from space 12, at which point a first portion 29a of air 29 is recycled back through system 10 and a second portion 29b of air 29 is exhausted from system 10. Recycled air 29a passes through NTP device 14 on its way back to space 12. NTP device 14 may include a blower for drawing air stream 27 and 29a into NTP device 14. Alternatively, a blower which is part of AHU 16 may be used to draw air into NTP device 14 and then through AHU 16.

Non-thermal plasma (NTP) device 14 is used to create a plasma of short-lived and long-lived reactive species that may react with volatile organic compounds (VOCs) and other contaminants, and remove the contaminants from the air. The plasma also produces ozone, which is well-suited for attacking VOCs and other contaminants. As shown in FIG. 1, device 14 is placed upstream of air handling unit 16 and is used to purify an air stream that includes outside air 27 and recycled air 29a.

Sensors 24 may be placed in various locations within HVAC system 10 and may be used to measure a concentration of various constituents in the air. For example, sensors 24 may be located within space 12 of FIG. 1 to measure and monitor contaminant levels within space 12. Sensors for measuring VOC levels may also be placed upstream of NTP device 14 to monitor VOC levels in air 27 entering system 10 and/or VOC levels in recycled air 29a. Moreover, sensors may be located within supply duct 18 downstream of NTP device 14 to monitor the effectiveness of NTP device 14 for removing contaminants from the air. Sensors 24 may also include sensors for measuring a concentration of microorganisms in the air at various locations within system 10.

In addition to sensors for monitoring VOCs and microorganisms, sensors 24 may also include sensors for monitoring a level of ozone. For example, if space 12 is occupied by humans during use of NTP device 14, it may be important to place ozone sensors in space 12 to monitor and ensure that the levels of ozone in air stream 28 are at or below a level that is acceptable to humans. In this case, it may be appropriate to mount ozone sensors near an exit of supply duct 18. Inputs from sensors 24 may thus include data from a plurality of sensors in any possible location within HVAC system 10 of FIG. 1.

The capability of air purification system 50 for purifying air is a function in part of controlling power from power supply 22 to NTP device 14 and controlling a flow rate of the air stream passing through NTP device 14 (as represented in FIG. 1 by flow rate control 26). Increasing power supply 22 to NTP device 14 results in NTP device 14 producing more ozone. More ozone increases the effectiveness of system 50 to remove contaminants from air. If less ozone is needed, supply 22 decreases power to NTP device 14.

Flow rate control 26 is configured to control a concentration of ozone in the air stream exiting NTP device 14. Decreasing a flow rate of air through NTP device 14, at a constant power setting, results in an increase in concentration of ozone in the air stream exiting plasma 60. An increased concentration of ozone results in a greater purification of the air stream. Power supply 22 and/or flow rate control 26 are adjusted as a function of data from sensors 24. As explained above, the data from sensors 24 may include, but is not limited to, ozone concentrations and/or VOC concentrations at various points within system 10.

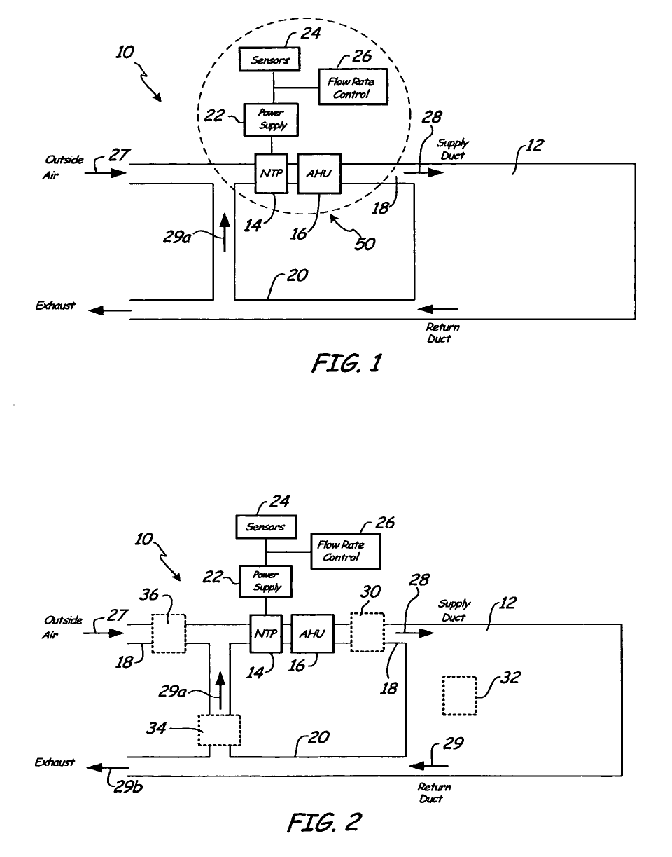

FIG. 2 is a schematic of air handling system 10 of FIG. 1 illustrating alternative or additional locations for an ozone generating device. As shown in FIG. 2, system 10 includes NTP devices 30, 32, 34, and 36, each of which may include a power supply (not shown) similar to power supply 22. Alternatively, power supply 22 may also be used to deliver power to more than one NTP device.

NTP device 30, as shown in FIG. 2, is placed downstream of AHU 16. In that case, NTP device 30 may likely be used as an alternative to NTP device 14. Instead of receiving outside air 27, as is the case with NTP device 14, NTP device 30 receives a conditioned air stream from AHU 16. Thus, in some cases, the air stream entering NTP device 30 may be at a lower humidity, as compared to outside air 27. In some cases, the NTP device may operate more efficiently if air entering the NTP device contains less humidity.

NTP device 32 is placed within space 12 and, as such, may operate as a stand alone unit. In that case, NTP device 32 may include its own blower. In some embodiments of system 10, NTP device 32 may be used in combination with NTP device 14. NTP device 14 may be used to remove contaminants from outside air 27 and recycled air 29a, which is then delivered to space 12 as clean air 28 through duct 18. NTP device 32 may be used to remove contaminants from air contained with space 12. The combination of NTP devices 14 and 32 facilitates a faster purification of the air contained within system 10.

NTP device 34 is shown inside return duct 20 at a position where exhaust air 29b has already been removed to outside, and recycled air 29a is being returned to supply duct 18. NTP device 34 may be used, similarly to NTP device 32, to remove contaminants from air coming from space 12. In those cases in which it is known that outside air 27 is essentially clean and does not need to be purified, then NTP device 34 may be used instead of NTP device 14. In that case, a lower flow rate may be used, since only recycled air 29a is passing through device 34. As stated above, a lower flow rate of air through the plasma device results, in some cases, in a higher efficiency of the plasma device due, in part, to the higher concentration of ozone in the air stream exiting the plasma device.

Finally, NTP device 36 is shown in FIG. 2 near an entrance to duct 18. NTP device 36 may be used alone or in combination with one of the other NTP devices of FIG. 2 when it is known that outside air 27 contains a high level of contaminants. In that case, recycled air 29a from space 12 does not pass through NTP device 36.

FIG. 2 illustrates that a single NTP device or multiple NTP devices may be used within system 10. It is recognized that multiple NTP devices may provide increased purification of air circulating through space 12; however, in some situations, it may not be cost effective to operate more than one NTP device within system 10. As shown in FIG. 2, an NTP device may be located within the duct work of system 10 or as a stand-alone unit within space 12. The NTP devices that are shown in the duct work in FIGS. 1 and 2 may be mounted inside the duct work as a semi-permanent fixture, or they may be portable units that are easily added, moved around, or removed from the ducts, as needed.

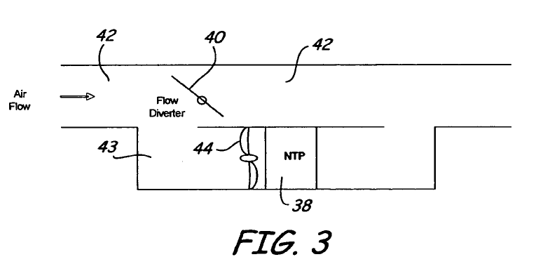

FIG. 3 illustrates an alternative embodiment of system 10 in which NTP device 38 is used in a duct by-pass configuration. As shown in FIG. 3, flow diverter 40 may be used to direct a portion of air flowing through duct 42 into duct by-pass 43. Air going through by-pass 43 then passes through NTP device 38. As shown in FIG. 3, NTP device 38 includes blower 44.

The embodiment shown in FIG. 3 may be used in a scenario where it is not necessary to purify all of the air passing through duct 42. Moreover, it is recognized that flow diverter 40 may be modified such that more or less air passes through by-pass duct 43. FIG. 3 further illustrates that the ozone generating device may be configured in a number of different ways within an HVAC system.

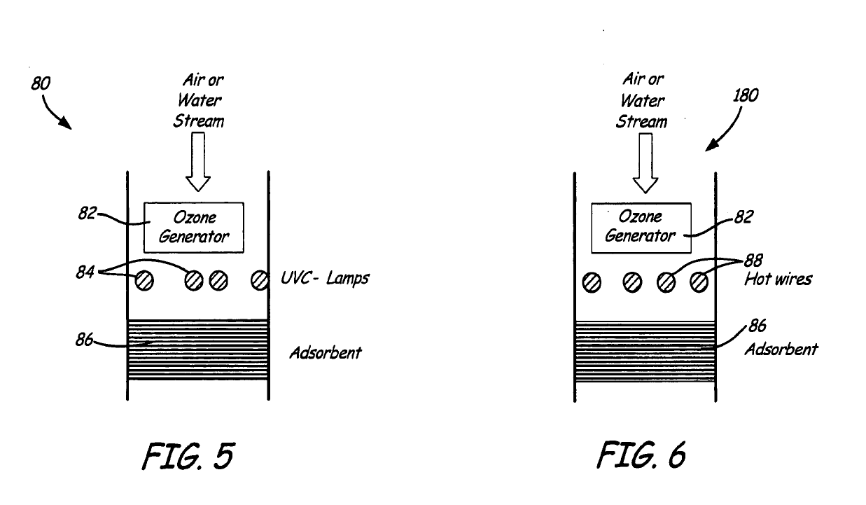

In preferred embodiments, air purification system 50 includes ozone generating device 14 in combination with an ozone decomposition device and a capturing device (i.e. an adsorbent and/or a particle filter) to localize the contaminants. Although ozone by itself may be used for purifying an air stream, there is an increased purification effect if ozone decomposition and a capturing device are part of the purification system and method. FIGS. 1-3 illustrate use of a purification system in an HVAC system to clean a contaminated air stream. It is recognized that the purification method and system described herein also may be used for purifying water. Exemplary embodiments for a purification system are described below in reference to FIGS. 5-11.

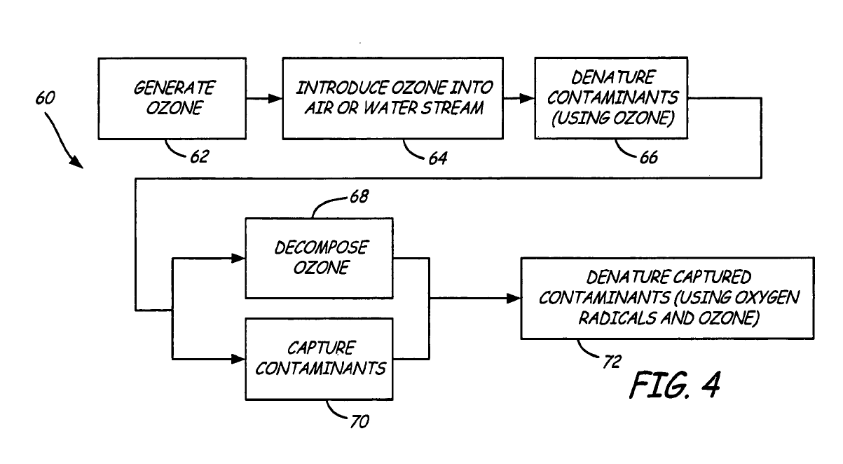

FIG. 4 is a block diagram illustrating method 60 for purification of a fluid stream using steps 62-72. An initial step in purification method 60 is to generate ozone (step 62). In the exemplary embodiments described above and shown in FIGS. 1-3, ozone is generated using a non-thermal plasma device. It is recognized that ozone may be generated using any known ozone generating device, as discussed below in reference to FIG. 5.

In step 64, the generated ozone may be introduced into a fluid (air or water). As described above in reference to FIG. 1, the fluid passes through the ozone generating device. As such, the generated ozone is commingled with contaminants, which may include VOCs and microorganisms, contained within the fluid. Common VOCs may include, but are not limited to, propanal, butene, toluene, and formaldehyde. At this point, in which ozone is in a gas-phase and the contaminants are in a gas-phase, ozone is well-suited to attack the contaminants and denature the contaminants (step 66) into something less harmful, relative to the original contaminants. (In those embodiments in which ozone is generated using a plasma device, it is recognized that other species produced by the plasma are also well-suited for attacking contaminants. This disclosure focuses on the use of ozone for purification, but it is recognized that the additional species formed by the plasma may also be effective at removing contaminants from a fluid stream.)

It is recognized that a purification system may only includes steps 62-66 and still be effective at removing contaminants from an air or water stream. This disclosure focuses on an increased effectiveness of a purification system through inclusion of steps 68-72.

Ozone survives for a substantial period of time (up to several hours) and thus may migrate downstream of the ozone generating device. As described above, in step 66, a portion of the ozone molecules will attack and denature the contaminants (VOCs and/or microorganisms). An ozone decomposition device may be used to break down or decompose a portion of the ozone molecules. The ozone molecules decompose into oxygen and an oxygen radical (step 68). The oxygen radical, which is extremely reactive, may then react with remaining VOCs and/or microorganisms in the fluid.

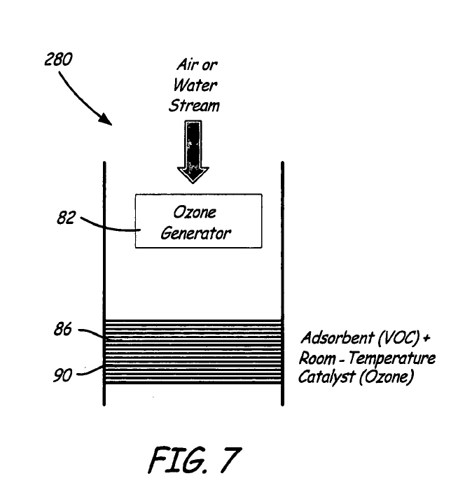

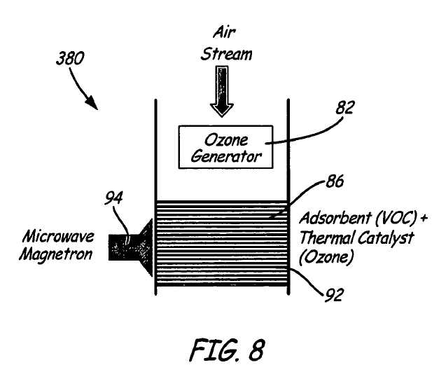

Step 68 may be performed using any known ozone decomposition device. For example, an ultraviolet light (UVC) source may be used to produce photons of energy that break down or decompose the ozone molecules. A light emitting diode (LED), hot wire or solar radiation may similarly be used for photolysis to decompose ozone. As further described below in reference to FIGS. 7 and 8, a catalyst may also be used to decompose ozone.

Although the oxygen radical is particularly well-suited for attacking and denaturing VOCs and microorganisms, the oxygen radical has a shorter lifespan, as compared to ozone. Thus, it is preferred that the oxygen radicals and the contaminants are in relatively close proximity to one another when the ozone is decomposed. A capturing device, which may include an adsorbent and/or a particle filter, may be used to capture the contaminants (step 70) remaining in the air or water stream. The capturing device captures or localizes the contaminants so that the oxygen radicals and the remaining ozone molecules, both of which are flowing with the air or water stream, have an increased probability of coming into contact with the captured contaminants.

In one embodiment, an adsorbent may be used in step 70 to capture and localize VOCs. It is known to use adsorbents in purification systems to remove VOCs from a fluid stream. However, a disadvantage of these types of systems is that the adsorbents may have to be replaced frequently once the adsorbent is no longer effective at reducing a concentration of VOCs in the fluid stream (i.e. an equilibrium is reached such that a concentration of VOCs at an outlet of the adsorbent is equal to a concentration of VOCs at an inlet of the adsorbent). Method 60 of FIG. 4 overcomes these limitations of an adsorbent through step 72, as explained below, by providing additional means for removing the VOCs from the fluid.

In step 70, VOCs are adsorbed using an adsorbent having a high affinity for VOCs. The adsorbent also may have an affinity for ozone and other molecules. Adsorbents which may be used in method 60 include, but are not limited to, titanium dioxide, activated carbon, manganese oxide, alumina, silica, or any other metal oxide and mixtures thereof.

As illustrated in FIG. 4, steps 68 and 70 may occur simultaneously. In some embodiments, the ozone decomposition device is placed upstream of the adsorbent. In other embodiments, steps 68 and 70 may be performed within the same device, as described below. Because the resulting oxygen radicals have a relatively short life, it is preferred that steps 68 and 70 are performed in close proximity within the system. Since ozone has a longer life as compared to other reactive molecules, placement of the ozone generating device, relative to the other components, may not be as critical. The ozone generating device may be in close proximity to the ozone decomposition device and the adsorbent, or the ozone generating device may be located further upstream.

In another embodiment, a particle filter may be used in step 70 to capture and localize larger-sized contaminants, such as microorganisms. The particle filter may be used as an alternative to the adsorbent or in addition to the adsorbent. As the air or water stream passes through the particle filter, microorganisms from the stream are captured by the particle filter.

Finally, in step 72 of method 60, the captured contaminants (VOCs and/or microorganisms) are denatured when the oxygen radicals, as well as ozone molecules, attack the captured contaminants. It is recognized that the oxygen radicals may attack the contaminants when the contaminants are in the gas phase (just as some of the contaminants will have already been attacked by the ozone molecules). However, by localizing the contaminants on the capturing device, there is an increased probability that a short-lived oxygen radical may come into contact with a captured contaminant. Moreover, step 72 increases an operational life of the capturing device, as described further below.

In those embodiments in which the capturing device is an adsorbent, by selecting an adsorbent having a high affinity for VOCs, the VOCs may form a relatively strong bond on the surface of the adsorbent (i.e. chemi-adsorption). Other molecules passing through the adsorbent (for example, ozone) may form a weaker bond (physi-adsorption). Because the adsorption process is highly dynamic, VOC molecules adsorbed on the surface are continuously being desorbed and then adsorbed again at a different location on the adsorbent. Thus, the VOC molecules may undergo a series of chemical reactions while in the adsorbed state. Depending on a size of the adsorbent, in some cases, the VOCs and other molecules in the adsorbed state may eventually form carbon dioxide and water molecules. It is recognized that, in other cases, the resulting molecules may not necessarily be benign or harmless. It is significant that the resulting molecules are less harmful than the original VOCs. Method 60 may be used to target specific contaminants by using a particular adsorbent. Similarly, when a particle filter is used as the capturing device, the microorganisms are denatured in step 72 to less harmful microorganisms, as a result of attack by ozone and/or oxygen radicals. In some cases the microorganisms may undergo repeated attack. By reacting ozone and oxygen radicals with the contaminants, the contaminants are denatured, rendering them less harmful.

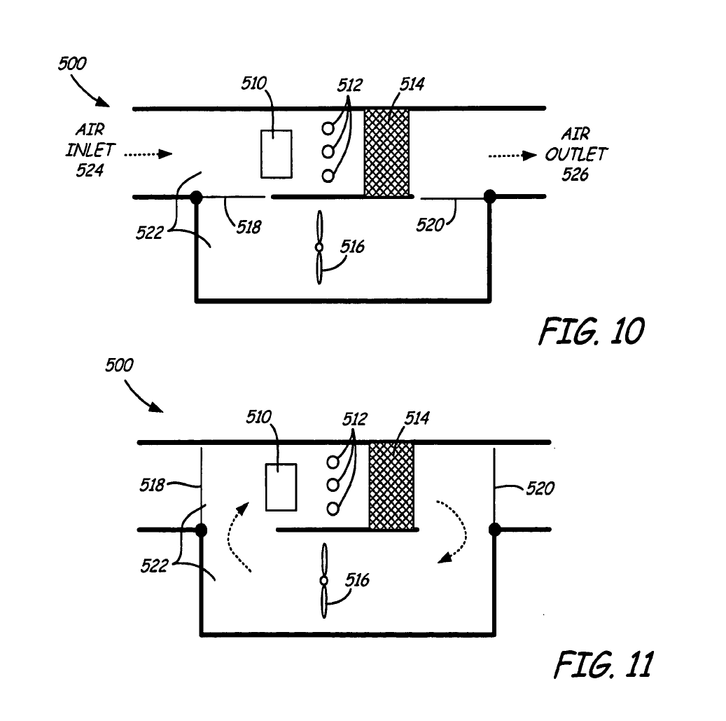

In the embodiment shown in FIG. 4, method 60 is a continuous process in which ozone generation (step 62), ozone decomposition (step 68) and capture of the contaminants (step 70) are continuously occurring as the air or water stream flows through the purification system. In an alternative method, a batch process may be used in which the contaminants are first captured and localized as the air or water stream flows through the purification system. In a separate phase, ozone is generated and decomposed to form a mixture of ozone molecules and oxygen radicals, which may then repeatedly attack the captured contaminants within a confined space. Through repeated attack of the contaminants, the VOCs may eventually be reduced to carbon dioxide and water. This batch process is described in further detail in references to FIGS. 10 and 11.

If a purification system used an adsorbent, but did not include ozone, the adsorbent would still adsorb the VOCs as described above. The VOC molecules would still cycle between an adsorbed and desorbed state on the adsorbent. However, in that scenario, because the ozone molecules and oxygen radicals are not present to attack the VOCs, the adsorbent would reach a saturation point in which the adsorbent was no longer able to reduce a concentration of the VOCs in the fluid stream passing through the adsorbent. An equilibrium would exist such that an outlet concentration of the VOCs would be equal to an inlet concentration of the VOCs, and the adsorbent would no longer be functional to reduce a level of contaminants in the fluid. A particle filter also has a limited life since a flow of fluid through the particle filter decreases over time as microorganisms (and other contaminants) buildup on the particle filter. In contrast, method 60 uses an adsorbent and/or a particle filter to localize the contaminants on the capturing device (step 70), and then provides a means of removing the contaminants from the capturing device (step 72) by reacting the contaminants with the ozone molecules and the oxygen radicals. The system is self-regenerating such that, with the aid of the ozone and oxygen radicals, the capturing device is able to continue to remove contaminants from the fluid stream without becoming saturated.

FIGS. 5-9 illustrate exemplary embodiments of purification systems that utilize method 60 of FIG. 4. FIG. 5 is a schematic diagram of purification system 80, including ozone generator 82, UVC lamps 84 and adsorbent 86. Purification system 80 is similar to air purification system 50 of FIG. 1. System 80 may include components similar to power supply 22, sensors 24 and flow rate control 26 of system 50, as shown in FIG. 1; these components have been omitted from system 80 in FIG. 5 for clarity. It is also recognized that sensors 24 and flow rate control 26 are not required in a purification system. Although not shown in FIG. 5, system 80 may include a particle filter, instead of adsorbent 86 or in addition to adsorbent 86, for trapping microorganisms in the fluid stream. This is described in further detail below.

Ozone generator 82 may include any device capable of generating ozone. As shown and described above in reference to FIGS. 1-3, a non-thermal plasma device may be used to generate ozone. Additional devices that may be used for ozone generator 82 include, but are not limited to, an ultraviolet (UVC) lamp and devices capable of creating a sufficiently strong electric field, such as a corona discharge device and other types of plasma devices. As shown in FIG. 5, an air or water stream, which may be contaminated, is directed through ozone generator 82, and the generated ozone is introduced into the air or water stream. In those cases in which the fluid stream passing through system 80 is water, ozone generator 82 may be an electrochemical ozone generator.

UVC lamps 84 are configured in system 80 for decomposing ozone molecules contained within the air or water stream. UVC lamps 84 produce photons of energy sufficient to decompose ozone molecules. When a photon contacts an ozone molecule, the ozone molecule decomposes into oxygen and an oxygen radical.

Adsorbent 86 is configured to adsorb or localize VOCs and other molecules, as the air or water stream passes through the adsorbent. Once the VOCs are adsorbed on adsorbent 86, there is a greater probability of denaturing the VOCs, as compared to if the VOCs continue to travel with the air or water stream passing through system 80. For example, an oxygen radical that is still in the gas phase may react with the adsorbed VOCs. In some embodiments, adsorbent 86 may also have an affinity for ozone molecules such that ozone molecules may be adsorbed by adsorbent 86. The adsorbed ozone molecules may then react with the adsorbed VOCs due to their close proximity to one another.

In preferred embodiments, adsorbent 86 has selectivity for various VOCs. Because UVC lamps 84 only decompose a portion of the ozone molecules, the air or water stream passing through adsorbent 86 may contain ozone molecules. As such, it may be advantageous to select an adsorbent material that also has an affinity for ozone.

Adsorbent 86 may include any known adsorbent material, and may be in various forms, such as a powder or pellets. In some embodiments, adsorbent 86 may be composed of more than one adsorbent material. For example, adsorbent 86 may include two types of pellets mixed together. A first type of pellets may have a high affinity for VOCs, and a second type of pellets may have a high affinity for ozone.

In preferred embodiments, adsorbent 86 is located in close proximity to UVC lamps 84. Because the oxygen radicals have a limited life, it is preferred that the photolysis process occur near to where the contaminants are in the adsorbed state. Moreover, UVC lamps 84 may be positioned within system 80 such that lamps 84 illuminate adsorbent 86. As such, lamps 84 decompose ozone molecules in the gas phase, as well as ozone molecules in the adsorbed phase. The resulting oxygen radicals are then well-placed to react with the adsorbed VOCs.

In the exemplary embodiment shown in FIG. 5, system 80 includes four UVC lamps 84. It is recognized that more or less lamps may be used depending on factors such as, but not limited to, the rate of purification required, the contamination levels of the air or water stream, and the capabilities of ozone generator 82. In some embodiments, UVC lamps 84 may optionally include shades or reflectors around the lamps so that the photons produced by lamps 84 only travel downstream (towards adsorbent 86) and are not able to travel upstream.

FIG. 6 is a second embodiment of a purification system that is similar to system 80 of FIG. 5. Purification system 180 includes some of the same components shown in FIG. 5, including ozone generator 82 and adsorbent 86. However, as an alternative to UVC lamps 84 of FIG. 5, system 180 of FIG. 6 includes hot wires 88 for decomposing ozone. The thermal energy from the hot wires 88 is used to break down the ozone molecules into oxygen and oxygen radicals.

As shown in FIG. 6, wires 88 are located upstream of adsorbent 86. In the embodiment shown in FIG. 6, system 180 includes four wires 88; however, it is recognized that more or less wires may be included in system 180. It is preferred that wires 88 are located in close proximity to adsorbent 86, due to the short life of the oxygen radicals.

In some embodiments, wires 88 may be located within adsorbent 86. For example, a honeycomb structure may be used and an adsorbent powder may be deposited onto the honeycomb to form adsorbent 86. Wires 88 may run through the apertures of the honeycomb. As ozone molecules pass through adsorbent 86, some of the ozone molecules may be adsorbed. Whether the ozone molecules are adsorbed or remain in the gas phase, thermal energy from wires 88 decomposes the ozone molecules. The resulting oxygen radicals are then able to attack the adsorbed VOCs.

FIG. 7 is another embodiment of a purification system. Purification system 280 includes ozone generator 82 and adsorbent 86. Instead of UVC lamps or hot wires, system 280 includes catalyst 90 for decomposing ozone.

In the embodiment shown in FIG. 7, adsorbent 86 and catalyst 90 are commingled together. Ozone from generator 82 is introduced into the air or water stream, which then passes through adsorbent 86 and catalyst 90. In this embodiment, catalyst 90 is a room-temperature catalyst. When ozone molecules come into contact with catalyst 90, the ozone molecules are decomposed into oxygen and oxygen radicals. Examples of room-temperature ozone catalysts include, but are not limited to, manganese oxide, palladium, and other oxides, including oxides with oxygen vacancies in their structure or oxides with multiple oxidation states, such as a titanium dioxide photocatalyst. Since adsorbent 86 is commingled with catalyst 90, the oxygen radicals are now in close contact with the adsorbed VOCs, and are able to react with and denature the VOCs.

In other embodiments, instead of being commingled together, catalyst 90 and adsorbent 86 may be distinct components within system 280. In that case, catalyst 90 may be located just upstream of adsorbent 86. Once the ozone molecules are decomposed, the oxygen radicals travel with the air or water stream to adsorbent 86 where the oxygen radicals are able to attack the adsorbed VOCs.

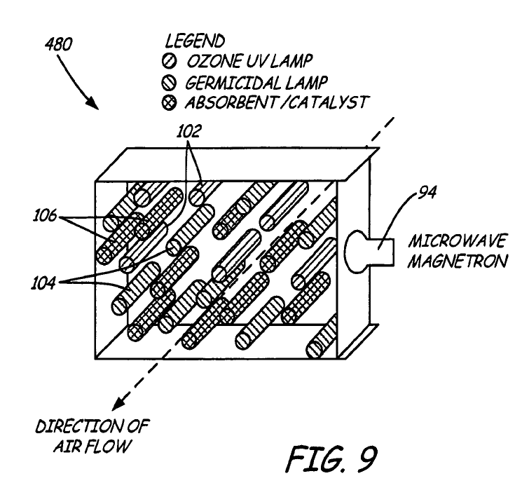

FIG. 8 illustrates another embodiment of a purification system which includes a microwave magnetron. Similar to system 280 of FIG. 7, purification system 380 includes ozone generator 82, adsorbent 86 and a catalyst. However, in this embodiment, system 380 includes microwave magnetron 94 having a microwave cavity, and catalyst 92 is a thermal catalyst. In the embodiments illustrated in FIGS. 5-7 and described above, the contaminated fluid may be air or water. In the embodiment illustrated in FIG. 8, as well as system 480 of FIG. 9, the fluid passing through purification system 380 is limited to air.

Adsorbent 86 and catalyst 92 are contained within the microwave cavity and receive microwave radiation produced by magnetron 94. Thermal catalyst 92 absorbs the microwaves from magnetron 94 and then decomposes ozone molecules that contact catalyst 92. Examples of thermal catalysts for decomposing ozone include, but are not limited to, activated carbon and boron carbide. To avoid thermal desorption of the VOCs adsorbed by adsorbent 86, in some embodiments, a material is selected for adsorbent 86 that does not significantly absorb microwave radiation. (It is recognized that, under certain conditions of temperature and pressure, all materials may absorb at least a minimal amount of microwaves.) Examples of this type of adsorbent include, but are not limited to, titanium dioxide, silicon dioxide, and aluminum oxide. Other materials that may be used for adsorbent 86, which may absorb microwave energy, include, but are not limited to, silicon carbide, molybdenum disilicide, titanium nitride, zirconium diboride, certain oxides (for example, zirconium oxide), various silicates, aluminosilicate, clays and carbon (including activated carbon). In other embodiments, adsorbent 86 and catalyst 92 may be the same material. For example, manganese oxide may be used as both an adsorbent and a thermal catalyst for decomposing ozone.

In an alternative embodiment, thermal catalyst 92 may be formed from a material that does not absorb microwaves from magnetron 94. In that case, an additional material (i.e. an absorber) may be included in system 380 to absorb the microwaves from magnetron 94 and thereby increase a temperature of thermal catalyst 92. The absorber would be commingled with thermal catalyst 92 so that it is in direct physical contact with catalyst 92 and thus able to provide heating to catalyst 92.

FIG. 9 is a schematic of an alternative embodiment of a purification system which also includes a microwave magnetron. In contrast to purification systems described above, the components of the purification system (ozone UV lamps 102, germicidal lamps 104, and adsorbent 106) are interspersed together and contained within a microwave cavity of microwave magnetron 94.

Lamps 102 and 104 are configured such that they are excited by microwaves, rather than electrodes located within the lamps. When microwave radiation is produced by microwave magnetron 94, ozone UV lamps 102 generate ozone, and germicidal lamps 104 decompose a portion of the generated ozone molecules. Similar to the adsorbents described above, adsorbent 106 is configured to selectively adsorb VOCs in the fluid stream passing through the microwave cavity. Adsorbent 106, as described above, may also adsorb other molecules, such as ozone molecules and oxygen radicals.

It is recognized that system 480 may include only one type of UV lamp, rather than distinct ozone generating lamps and germicidal (decomposition) lamps. If only one type of lamp were used, those UV lamps would simultaneously create and dissociate ozone.

It is recognized that other configurations of a purification system not specifically shown and described herein may be used to implement method 60 of FIG. 4. These additional configurations would similarly include a method of introducing ozone into the fluid stream and a method of decomposing the ozone to form oxygen radicals. An adsorbent is used to localize the contaminants such that the ozone and oxygen radicals are able to react with and denature the VOCs in an adsorbed state. This increases a purification effect of the system, as compared to if the ozone and oxygen radicals only attack the VOCs in the gas phase.

The adsorbents described above and shown in FIGS. 5-9 are configured for capturing or localizing VOCs contained within a fluid passing through the adsorbent. Many types of contaminants, in addition to volatile organic compounds (VOCs) may be contained with the fluid. For example, the contaminants may also include microorganisms, which are larger than the VOCs. As described above in reference to method 60 of FIG. 4, a particle filter may be used to capture these microorganisms as the fluid passes through the particle filter. A particle filter may be used in the embodiments of FIGS. 5-8, instead of using an adsorbent. In other embodiments, the particle filter may be used in addition to the adsorbent.

For example, in purification systems 80 and 180 of FIGS. 5 and 6, respectively, adsorbent 86 may be replaced by a particle filter, which may be, for example, a HEPA filter or formed from activated carbon. Instead of adsorbing VOCs, the particle filter acts as a sieve that allows air and other relatively small molecules to pass through it, while trapping larger particles, such as microorganisms. Similar to adsorbent 86, the particle filter localizes the microorganisms such that the ozone molecules and oxygen radicals attack the microorganisms, as the ozone and oxygen radicals pass through system 80. As described in reference to the adsorbent, the denaturing of the microorganisms by the ozone and oxygen radicals similarly increases an operational life of the particle filter.

In an alternative embodiment, a particle filter may be used in purification systems 80 and 180, in addition to adsorbent 86. Referring to system 80 of FIG. 5 as an example, if the particle filter is used in addition to adsorbent 86, the particle filter may be located between ozone generator 82 and UVC lamps 84. In those embodiments in which ultraviolet light is used for decomposing ozone molecules, it may be beneficial to place the particle filter upstream of the ozone decomposition device (i.e. UVC lamps 84 in FIG. 5), since the particle filter may block the photons produced by UVC lamps 84. However, in some embodiments, a UV transparent material may be used to form the particle filter, in which case it is not significant where the particle filter is placed relative to the ozone decomposition device. In those embodiments in which the ozone decomposition device does not produce ultraviolet light (for example, hot wires 88 of FIG. 6), the particle filter may be located essentially anywhere downstream of the ozone generating device. It may be preferred in some cases that the particle filter be located in close proximity to the ozone decomposition device so that the oxygen radicals are close to the captured microorganisms.

For purposes of this disclosure, a capturing device may refer to various devices that are capable of removing contaminants from a fluid using various methods. As described herein, the capturing device may be an adsorbent and/or a particle filter. In some cases, the removal may be accomplished via physi-adsorption or chemi-adsorption of molecules (i.e. VOCs), whereas in other cases, the removal is done by filtering or trapping the particles based on a size of the particles. In some embodiments, the capturing device may be capable of both adsorbing VOCs and trapping the larger microorganisms. For example, carbon fibers may be used as an adsorbent and a particle filter. Alternatively, fibers which may be used as a filter may also be coated with a material that results in adsorption of the VOCs.

As similarly described above for an adsorbent (see FIGS. 7 and 8), a catalyst may be included with the particle filter for decomposing ozone. The fibers that make up the particle filter may be a catalytic material that decomposes the ozone, or the fibers may be coated with a material that decomposes ozone. The catalyst may be a room temperature catalyst or a thermal catalyst.

In some embodiments, the purification systems described herein may also include an ozone mitigating device. As stated above, ozone molecules may survive for a substantial period of time. Since ozone is dangerous above a minimum concentration level, it may be important to remove any ozone molecules remaining in an air stream exiting the purification systems of FIGS. 5-9. For example, a filter formed of activated carbon, or a manganese oxide catalyst, may be used to capture any remaining ozone molecules, particularly before the air is released into an occupied space. Referring to purification system 80 of FIG. 5, an ozone filter may be located downstream of adsorbent 86.

FIGS. 10 and 11 illustrate an alternative embodiment for purifying a contaminated air stream, using an ozone generator, an ozone decomposition device and a capturing device. In the embodiments described above, purification of the fluid is a continuous process. The steps of the purification process (generating ozone, decomposing ozone and capturing contaminants) occur simultaneously as the fluid continues to flow through the purification system. As described below, in an alternative embodiment, a two-phase process, which is performed in a regeneration chamber, may be used for air purification. In the first phase, a capturing device (i.e. an adsorbent or particle filter) captures the contaminants from the air, as the air passes through the regeneration chamber. In the second phase, air is prevented from entering or exiting the regeneration chamber, and ozone and oxygen radicals repeatedly attack the captured contaminants.

FIG. 10 is a schematic of air purification system 500, which may be included in an HVAC system (similar to system 10 of FIG. 1). Purification system 500 includes ozone generator 510, ozone decomposition device 512, adsorbent 514, fan 516, and dampers 518 and 520, all of which are contained within regeneration chamber 522. In the first phase, regeneration chamber 522 is in an open position such that an air stream flows through system 500 (via inlet 524 and outlet 526). During this first phase, which may be referred to as an adsorption phase, ozone generator 510 and ozone decomposition device 512 are turned off. As the air stream flows through adsorbent 514, contaminants in the air stream, particularly VOCs, are adsorbed by adsorbent 514 and thus removed from the air stream. System 500 continues to operate in this first phase either for a predetermined period of time or until adsorbent 514 reaches equilibrium, as described in further detail below.

FIG. 11 illustrates a second phase in the purification process, referred to as a regeneration phase. As shown in FIG. 11, regeneration chamber 522 is in a closed position. Dampers 518 and 520 are moved to a vertical position such that dampers 518 and 520 prevent any air from entering or exiting regeneration chamber 522. The air contained within regeneration chamber 522 is circulated around chamber 522 using fan 516. During the regeneration phase, ozone generator 510 and ozone decomposition device 512 are turned on. Ozone molecules and oxygen radicals are thus introduced into the air circulating around regeneration chamber 522.

Any contaminants remaining in the air inside regeneration chamber 522 are either adsorbed by adsorbent 514 or attacked by the ozone molecules and oxygen radicals. As the ozone molecules and oxygen radicals pass through adsorbent 514, VOCs in an adsorbed state are attacked and denatured. Because ozone and oxygen radicals continue to be produced inside regeneration chamber 522, the adsorbed VOCs are repeatedly attacked by ozone and oxygen radicals. Ultimately, the VOCs may be reduced to carbon dioxide and water. As a result, the VOCs are removed from adsorbent 514, which regenerates adsorbent 514. At that point, the adsorption phase may be repeated since adsorbent 514 is able to capture additional VOCs.

As mentioned above, purification system 500 may be part of the HVAC system in a building. System 500 may be configured such that system 500 changes over from the adsorption phase in FIG. 10 to the regeneration phase in FIG. 11 on a periodic basis. For example, if the building is occupied during the day, but not during the evening and night, system 500 may be designed such that the adsorption phase is used during the daytime hours to purify an air stream for delivering clean air to the building. Then when the building is unoccupied, the regeneration phase is used to regenerate the adsorbent and make the adsorbent available for further contaminant removal.

System 500 also may be configured such that it changes over from the adsorption phase to the regeneration phase when adsorbent 514 becomes saturated such that a concentration of VOCs at an outlet of adsorbent 514 is equal to a concentration of VOCs at an inlet of adsorbent 514. System 500 may operate temporarily in the regeneration phase in order to regenerate adsorbent 514. An advantage of the embodiment of system 500 is that adsorbent 514 may have a reduced mass, yet have a capacity that is comparable to a larger-sized adsorbent because adsorbent 514 may be reused after the regeneration phase.

In some embodiments, system 500 may optionally include a heater within regeneration chamber 522 to increase a temperature inside chamber 522 during the regeneration phase. A higher temperature promotes desorption of the VOCs adsorbed on adsorbent 514. In that case, the desorbed VOCs return to a gas phase, at which point the VOCs may be attacked in the gas phase by the ozone molecules and oxygen radicals within regeneration chamber 522. It is recognized that, in some embodiments, ozone generator 510 and ozone decomposition device 512 may increase a temperature inside chamber 522. For example, if ozone decomposition device 512 includes at least one UVC lamp, the UVC lamps provide heat to chamber 522.

In some embodiments, system 500 may include an ozone mitigating device, which would be located downstream of adsorbent 514. The ozone mitigating device may be used at an end portion of the regeneration phase after ozone generator 510 is turned off. Because ozone molecules may survive for up to several hours, the ozone mitigating device may be used to remove any remaining ozone molecules from chamber 522. This may be important if the adsorption phase is going to be repeated and air flowing through system 500 is traveling to an occupied space. As an alternative to an ozone mitigating device, system 500 may operate in the regeneration phase for a period of time with ozone generator 510 turned off and ozone decomposition device 512 on. In that case, the remaining ozone molecules in chamber 522 may be decomposed into oxygen and oxygen radicals, and/or react with other molecules.

It is recognized that system 500 of FIGS. 10 and 11 may be operated as a continuous process; in which case system 500 is similar to the embodiments shown in FIGS. 5-9. System 500 would operate with regeneration chamber 522 in the open position (FIG. 10). Air is thus permitted to flow into and out of chamber 522, while ozone generator 510 and ozone decomposition device 512 operate as described above, in combination with adsorbent 514.

As described above in reference to FIGS. 5-8, a particle filter may similarly be used in system 500 in addition to or as an alternative to adsorbent 514. The particle filter traps microorganisms in the air stream passing through chamber 522 during the adsorption phase. In the regeneration phase, the microorganisms on the particle filter may be repeatedly attacked by ozone molecules and oxygen radicals circulating around regeneration chamber 522.

In some embodiments, ozone decomposition device 512 may be omitted from system 500 (or device 512 may be turned off during operation of system 500). In that case, the attack of the captured contaminants during the regeneration phase is done by essentially only the ozone molecules from ozone generator 510 (as opposed to both the ozone molecules and the oxygen radicals). The ozone molecules are still effective at denaturing the contaminants and removing them from the capturing device. The adsorption phase may then still be repeated as described above. However, because the oxygen radicals are particularly effective at attacking the contaminants, it is recognized that system 500 may be more efficient when the ozone generator is used in combination with an ozone composition device.

The purification system described herein may be used in a variety of applications in which it is necessary or beneficial to clean up a contaminated air or water stream. The purification system may be used for purifying air and/or water in a building. For example, as described in reference to FIGS. 1-3, the purification system may be used in the ducts of an HVAC system for cleaning an air stream passing through the duct system. The system also may be used for purifying air and/or water in any type of transportation device, including spacecraft, aircraft, land vehicles, cruise lines and other types of marine craft.

Although the present invention has been described with reference to preferred embodiments, workers skilled in the art will recognize that changes may be made in form and detail without departing from the spirit and scope of the invention.

1. A method of purifying a fluid containing contaminants, the method comprising:
a) capturing the contaminants from the fluid to localize the contaminants using a capturing device;
b) generating ozone molecules using an ozone generating device;
c) decomposing a portion of the ozone molecules into oxygen and oxygen radicals; and
d) reacting the captured contaminants with the oxygen radicals and the ozone molecules to denature the contaminants, wherein the oxygen radicals and the ozone molecules are present in an amount sufficient to regenerate the capturing device.

2. The method of claim 1 wherein the capturing device includes a particle filter.

3. The method of claim 1 wherein the capturing device includes an adsorbent.

4-5. (canceled)

6. The method of claim 1 wherein the fluid includes at least one of water and air.

7. The method of claim 1 wherein decomposing a portion of the ozone molecules is performed by at least one of a UVC lamp, a light emitting diode (LED), solar radiation, a hot wire, an adsorbent, a catalyst, and a microwave magnetron.

8. The method of claim 1 wherein the ozone generating devices includes at least one of a UVC lamp, a corona discharge device, a plasma device, and an electrochemical ozone generator.

9. The method of claim 1 further comprising:
creating a confined, regeneration chamber prior to step b) to prevent fluid from entering or exiting the regeneration chamber; and
circulating the fluid in the regeneration chamber.

10. The method of claim 9 wherein steps b) through d) are repeated as the fluid continues to circulate in the regeneration chamber, resulting in repeated attack of the captured contaminants.

11. (canceled)

12. The method of claim 9 wherein the ozone generating device in step b) is turned off and steps c) and d) continue until a concentration of ozone in the regeneration chamber is below a predetermined level.

13. The method of claim 1 further comprising:
removing unreacted ozone molecules from the fluid using an ozone mitigating device.

14. A system for purification of a fluid containing contaminants, the system comprising:
a capturing device configured to remove the contaminants from the fluid as the fluid passes through the capturing device;
an ozone generating device configured to generate ozone molecules; and
an ozone decomposition device configured to decompose a portion of the ozone molecules into oxygen and oxygen radicals, wherein the ozone molecules and the oxygen radicals react with the captured contaminants to denature the contaminants, and wherein the ozone is generated in amount so that following the decomposition of a portion of the ozone, there is a sufficient amount of oxygen radicals and ozone molecules to regenerate the capturing device.

15. The system of claim 14 wherein the contaminants include at least one of microorganisms and volatile organic compounds (VOCs).

16. The system of claim 14 wherein the capturing device is a particle filter.

17. The system of claim 14 wherein the capturing device is an adsorbent.

18-21. (canceled)

22. The system of claim 17 wherein the contaminants in the fluid include microorganisms and the system further comprises a particle filter configured to remove the microorganisms from the fluid.

23. The system of claim 22 wherein the particle filter is located downstream of the ozone generating device and upstream of the ozone decomposition device.

24. The system of claim 22 wherein the particle filter is located downstream of the ozone decomposition device.

25. The system of claim 14 wherein a portion of the ozone molecules attack a portion of the contaminants before the contaminants are captured by the capturing device.

26. The system of claim 14 wherein the ozone decomposition device includes at least one of a UVC lamp, a light emitting diode (LED), solar radiation, a hot wire, an adsorbent, a catalyst, and a microwave magnetron.

27. (canceled)

28. The system of claim 14 wherein the ozone generating device includes at least one of a plasma device, a corona discharge device, a UVC lamp, and an electrochemical ozone generator.

29-52. (canceled)
